(19) United States
(12) Patent Application Publication
(10) Pub. No.: US 2003/0038979 A1
(43) Pub. Date: Feb. 27, 2003

(54) Printer

(75) Inventors: Takao Seki, Nagoya-shi (JP); Kiyotaka Ohara, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/225,432

(22) Filed: Aug. 22, 2002

(30) Foreign Application Priority Data
Aug. 24, 2001 (JP) 2001-254441

(51) Int. Cl. B41J 1/00; G06F 15/00; H04N 1/00

(52) U.S. Cl. 358/402; 358/1.15

(57) ABSTRACT

A printer for transmitting and receiving image data as an email message over the Internet regardless of the type of attached data. The printer performs two different types of printing processes. As to BIP, only if an email message has attached data which is considered print data, a printing process for forming the image by using the print data is selected. If an email message has attached data which is in TIFF-F format, iFAX, the process for converting the attached data to print data and then forming the image by using the print data is selected. Therefore, regardless of the type of the data attached to the email, the type of the attached data is automatically determined. A proper printing process is selected based on the result of the determination.

### BACKGROUND OF THE INVENTION

1. Field of the Invention

The present invention relates to a printer for generating images from data attached to an email message received across email transmission networks.

2. Description of the Related Art

Network facsimile machines include a function for transmitting facsimile data over the Internet by attaching the facsimile data, which is generally transmitted by facsimile transmission across public telephone lines, to an email message. Because the network facsimile machine enables a facsimile transmission across the Internet, a facsimile message can be sent to a remote location at low cost. For this reason, network facsimile machines have become quite common, as use of the Internet increases.

Facsimile data normally consists of binary image data in TIFF-F Format. Email messages, however, can basically only include text data. In recent years, “Internet Fax” (iFax) has become a popular method for facsimile transmission over the Internet. According to the iFax, a transmitting device first encodes image data in the TIFF-F format using BASE 64 encoding based on Multipurpose Internet Mail Extensions (MIME) standards in order to convert the image data into text data. Next, the transmitting device attaches the text data as an attachment to an email message, and then transmits the email message. The receiving device receives the email message, decodes the attached data of the email message to image data in the TIFF-F format, and then converts the image data into print data for printing.

Brother Internet Print (BIP) is another network print transmission technology for forming images from data attached to an email message in a manner similar to iFAX facsimile transmission. Next, BIP will be explained in detail. In BIP, the transmitting device converts image data using a printer driver into print data that a receiving device can print out. The transmitting device then encodes the print data in accordance with MIME standards, and attaches the encoded data to an email message as an attachment. The receiving device then receives the email message, decodes the attached data of the email message according to MIME standards into print data, and then prints out the print data.

With BIP, image data is transmitted as print data, rather than as image data as in the case of iFAX. For this reason, the transmitter device prepares print data available for the printing characteristics of the receiving device, and sends the print data as a part of an email message to the receiving device. Therefore, the reception device has a resolution which is not restricted to that of iFAX. That is, BIP enables the receiving device to print out the image at a resolution that is equal to or higher than those set by iFAX transmission standards.

Under iFax, a receiving device has to perform two processes: one for decoding received image data in accordance with MIME standards, and another for converting the decoded image data into print data. In contrast, under BIP, a receiving device need only decode the received print data in accordance with MIME standards to the print data being printed out. That is, there is no need for the receiving device to convert the encoded image data into print data.

### SUMMARY OF THE INVENTION

Both iFAX and BIP transmit data attached to email messages. However, the type of attached data is different. That is, with iFAX, the attached data is based on image data, and with BIP, the attached data is based on print data. Also, iFAX and BIP require different processes when printing is performed based on the attached data. That is, with iFAX, the attached image data is first required to be converted to print data. For this reason, if a BIP printer receives an iFAX email message, it will be unable to print based on the attached data.

It is an objective of the problem information to overcome the above-described problems and provide a printer capable of forming images based on data attached to email messages regardless of the type of the attached data.

The present invention features a printer comprising: a receiving unit that receives, across an email transmission network, an email message attached with data; an image forming unit that forms an image on a sheet; and a control unit that controls the image forming unit to form on the sheet an image based on the data attached to the email message, the control unit including: a determination unit that determines type of the attached data; and a selection unit that selects a printing process in accordance with the type of the attached data as determined by the determination unit, the control unit controlling the image forming unit in accordance with the printing process selected by the selection unit.

According to another aspect of the invention, a printer is characterized by comprising: a unit that accesses a mail server of an email transmission network to obtain information related to the email arrived at the server; a unit that makes a list of the email based on the information; a determination unit that determines type of data attached to the email on the list to classify the email into two groups of email according to determined type; a receiving unit that receives one of the two groups of email from the mail server; a selection unit that selects one of two different types of printing processes that corresponds to the received group of email; an image forming unit that uses the selected printing process to form an image according to the data attached to the received email.

According to further aspect of the invention, a printer is characterized by comprising: a receiving unit that receives email attached with data transmitted over a transmission network; a decoding unit that decodes the data attached to the email; a determination unit that determines whether the decoded data is image data or print data; a conversion unit that converts the image data to the print data; and an image forming unit that forms an image on a sheet according to the print data, wherein the conversion unit is activated only if the decoded data is image data.

### BRIEF DESCRIPTION OF THE DRAWINGS

The above and other objects, features and advantages of the invention will become more apparent from reading the following description of the embodiment taken in connection with the accompanying drawings in which:

FIG. 1 is a perspective view showing a facsimile machine according to the present invention;

FIG. 2 is a cross-sectional view showing internal configuration of the facsimile machine of FIG. 1;

FIG. 3 is a block diagram showing the facsimile machine of FIG. 1;

FIG. 4 is a flowchart showing a main routine of network facsimile procedures;

FIG. 5 is a flowchart showing a list preparing routine;

FIGS. 6A and 6B are examples of a TOP LIST made by using the routine represented by the flowchart of FIG. 5;

FIG. 7 is a flowchart showing an iFAX reception routine; and

FIG. 8 is a flowchart showing a BIP reception routine.

### DETAILED DESCRIPTION OF THE EMBODIMENT

Next, a facsimile machine 2 according to an embodiment of the present invention will be described while referring to the attached drawings. The facsimile machine 2 has a facsimile function, a network facsimile function, a printer function, and a copy function. With the facsimile function, the facsimile machine scans images on a document, and transmits the scanned image data as facsimile data across a telephone line to a remote facsimile machine. The facsimile machine also receives facsimile data transmitted over a telephone line from a remote facsimile machine, reproduces image data from the received facsimile data, and prints out the image data onto sheets.

With the network facsimile function, the facsimile machine 2 receives an email message across communication networks, such as the Internet or a local area network (LAN), and forms images on sheets based on data attached to the email message.

With the printer function, the facsimile machine 2 receives code data transmitted through a printer cable from a personal computer or a word processor, and forms images on sheets according to the code data. With the copy function, the facsimile machine 2 retrieves images from documents and prints out copies of the document image on sheets.

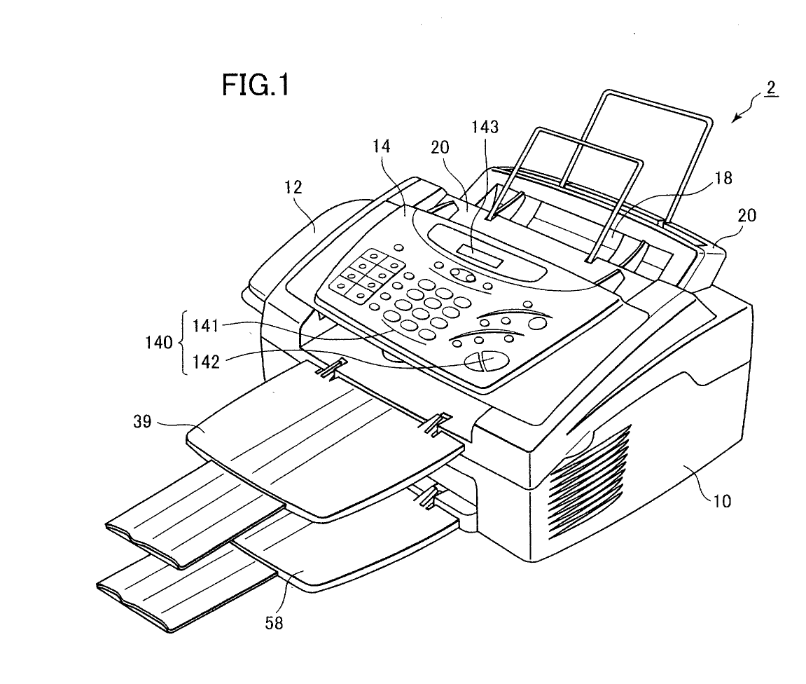

The external configuration of the facsimile machine 2 will be described. As shown in FIG. 1, the facsimile machine 2 has a main body 10, a handset 12, an operation panel 14, and trays 16, 18, and 20. The handset 12 is attached to one side of the main body 10. The operation panel 14 is provided to the front end of the upper surface of the main body 10. The first sheet-supply tray 16 is provided at the rear of the upper surface of the main body 10 for supplying recording sheets. The second sheet-supply tray 18 is disposed above the first sheet-supply tray 16. The third sheet-supply tray 20 is provided above the second sheet-supply tray 18.

The operation panel 14 includes operation keys 140 and a liquid crystal display 143. The operation keys 140 include numeric keys 141 and a start button 142. The liquid crystal display 143 displays information related to different kinds of functions of the facsimile machine 2.

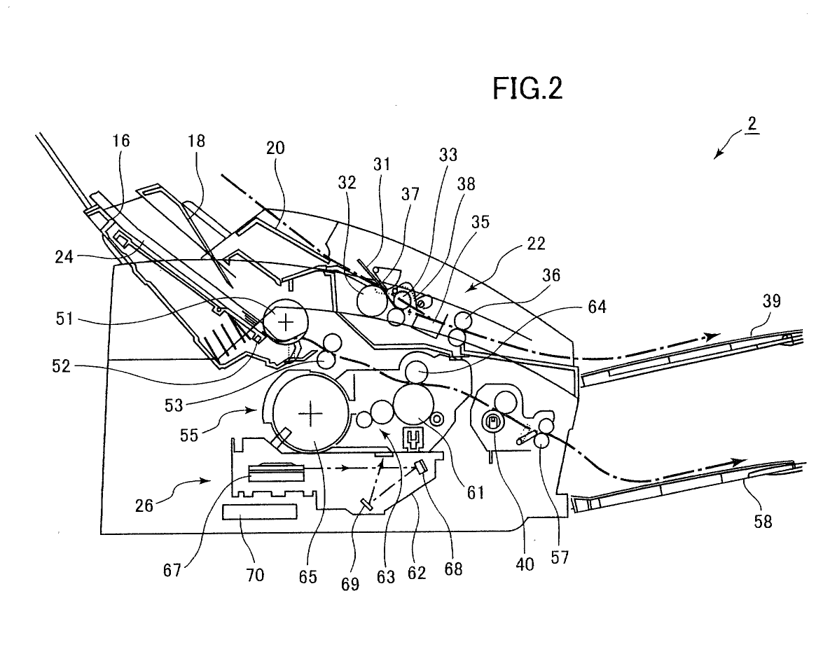

Next, internal configuration of the facsimile machine 2 will be described with reference to FIG. 2. The main body 10 houses a scanner 22, a recorder 26, and a control 70. The scanner 22 scans images on documents placed on the third sheet-supply tray 20. The recorder 26 forms images on sheets 24 stacked on the first sheet-supply tray 16. The control 70 controls operations of different components of the facsimile machine 2.

The scanner 22 includes a sheet-feed roller 32, a separation pad 31, transport rollers 33, an image retrieval unit 35, and discharge rollers 36. The sheet-feed roller 32 and the separation pad 31 draw in one document-sheet from the stacked document-sheets placed on the third sheet-supply tray 20. The transport rollers 33 transport the document-sheet to the image retrieval unit 35. The image retrieval unit 35 retrieves an image from each document-sheet. Then, the discharge rollers 36 discharge the document-sheet onto a discharge tray 39 that is provided on the front surface of the main body 10.

The scanner portion 22 further includes a front edge sensor 37 and a rear edge sensor 38 provided in the pathway from the third sheet-supply tray 20 to the sheet-feed roller 32 and the separation pad 31. The front edge sensor 37 detects the front edge of a document-sheet, and the rear edge sensor 38 detects the rear edge of the document sheet.

The recorder 26 is configured in the same manner as that of a laser printer. The recorder 26 forms images on a recording sheet 24 based on commands from the control 70. The recorder 26 includes a sheet-supply roller 51, a separation pad 52, transport rollers 53, an image forming unit 55, a fixing unit 40, and sheet-discharge rollers 57. The sheet-supply roller 51 and the separation pad 52 draw in recording sheets 24 one by one from either the first sheet-supply tray 16 or the second sheet-supply tray 18. The transport rollers 53 transport the recording sheet 24 to the image forming unit 55. The image forming unit 55 forms an image by toner on the recording sheet 24. The recording sheet 24 with a toner image being formed is transported to the fixing unit 40. The fixing unit 40 fixes the toner images onto the recording sheet 24. Then, the sheet-discharge rollers 57 discharge the recording sheet 24 onto a discharge tray 58 provided at the front surface of the main body 10.

The image forming unit 55 includes a photosensitive drum 61, a laser scanner 62, a developing unit 63, a transfer roller 64, and a toner tank 65. The laser scanner 62 irradiates the photosensitive drum 61 with a laser beam to form a latent electrostatic image on the surface of the photosensitive drum 61. The developing unit 63 impinges toner on the latent electrostatic image of the photosensitive drum 61. The transfer roller 64 applies a voltage to the recording sheets 24, so that the toner clinging to the photosensitive drum 61 is transferred to the recording sheet 24. The toner tank 65 includes toner. The laser scanner 62 includes a polygon mirror 67 and reflection mirrors 68, 69. While rotating, the polygon mirror 67 reflects a laser beam emitted by commands from the control 70. The mirror 68 reflects the laser beam reflected by the polygon mirror 67. The reflection mirror 69 reflects the laser beam reflected by the mirror 68 to the photosensitive drum 61.

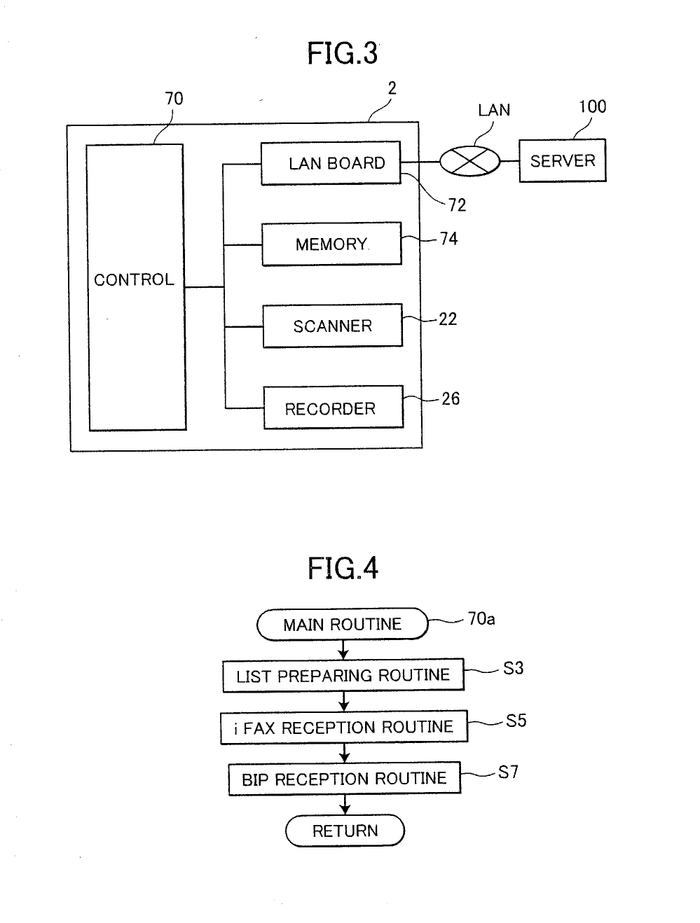

Next, main units of the facsimile machine 2 will be described with reference to the block diagram of FIG. 3 As shown in FIG. 3, the facsimile machine 2 further includes a LAN board 72 and a memory 74 in addition to the scanner 22, the recorder 26, and the control 70. The LAN board 72 and the memory 74 are connected to the control 70 along with the scanner 22 and the recorder 26. The LAN board 72 is connected to a server 100 via a local area network (LAN).

In this embodiment, an email message received from the server 100 includes attached data which was encoded into text data using BASE 64 coding based on MIME standards. When the facsimile machine receives an email message including attached data, the attached data is decoded in the LAN board 72 to the original data. The decoded data is then stored in the memory 74.

The control 70 controls the operations of the LAN board 72, the memory 74, the scanner 22, and the recorder 26. The control 70 executes two different types of printing processes. The first type of printing process is performed when an iFAX email message is received. The second type of printing process is performed when a BIP email message is received.

In the first printing process, because image data is decoded from the received data by the LAN board 72, the control 70 converts image data stored in the memory 74 into print data. The control 70 then controls the recorder 26 to print images based on the print data onto recording sheets.

In the second printing process, because print data is decoded from the received data by the LAN board72 and the decoded print data is stored in the memory 74, the control 70 controls the recorder 26 to print images based on the print data in the memory 74 on recording sheets. As described above, an email message received in an iFAX type facsimile transmission across the Internet is attached with image data that was encoded in TIFF-F format. Therefore, the attached data is decoded into image data and stored in the memory 74. On the other hand, an email message received in a BIP type network printing transmission includes print data that was converted to print data before being encoded and attached to the email message. Therefore, the attached data is decoded into print data and stored in the memory 74.

Here, an explanation will be provided for email messages. Email messages mainly consist of three parts: a header, a message body, and an attached file. The header includes address of the addressee, name of the sender, and a subject title. The message body includes the textual portion of the message. The attached file includes any kind of data attached to the email message such as image data and print data. In the present embodiment, if the attached file includes BIP print data, then either the header or the head of the message body is provided with a BIP indicator. The BIP indicator represents that the encoded contents of the attached data is print data.

Next, various control operations by the control 70 with respect to the network facsimile function will be described. It should be noted that the functions described above except the network facsimile function are well-known, so that their description will be omitted.

First, a main routine 70a will be described with reference to the flowchart in FIG. 4. The main routine 70a is executed when the power is turned ON or a predetermined command is received through the operation panel 14. Alternatively, the main routine 70a is executed at a predetermined check time interval.

When the main routine 70a starts, first a list preparing routine is performed in S3. The list preparing routine determines the data amount of a received email message, and the type of the attached file. After the list preparing routine is completed, then an iFAX reception routine starts in S5. The iFAX reception routine receives and prints iFAX email messages. Next, a BIP reception routine is performed in S7. The BIP reception routine receives and prints BIP email messages. The main routine 70a is executed each time a check time elapses, until the power of the facsimile machine 2 is turned OFF.

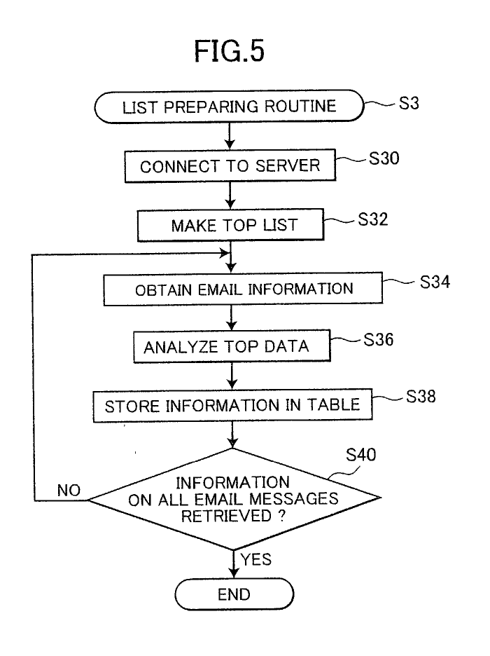

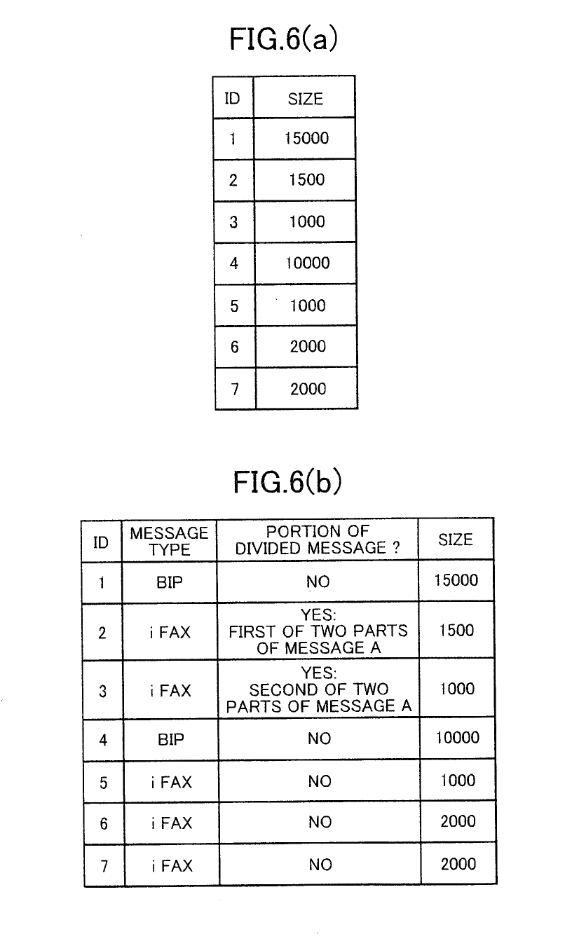

Next, the list preparing routine (step S3) will be explained with reference to FIGS. 5, 6A, and 6B. When the list preparing routine starts, the connection between the facsimile machine 2 and the server 100 is established in S30. Next, in S32, the facsimile machine 2 sends to the server 100 a LIST command to request the server 100 to transmit information on email messages arrived at the server to the facsimile machine 2. In response to the command, a procedure for making a list on the information is started. The server 100 assigns an identifying (ID) number to each email message being received by the facsimile machine 2. The information related to both the ID number and the email message size is then transmitted to the facsimile machine 2. The facsimile machine 2 makes a TOP LIST shown in FIG. 6A based on the received information. The TOP LIST indicates the correspondence between the ID numbers and the size of email messages.

Next, in S34, a procedure for analyzing email is executed. During this procedure, the facsimile machine 2 first transmits a “TOP 1 16” command to the server 100. This command is a request for the server 100 to transmit the header and the first 16 rows of data from the message body of the email message with ID number of “1” to the facsimile machine 2. The server 100 then transmits the header and the first 16 rows of data from the message body of the email message with ID number of “1” to the facsimile machine 2. Therefore, in S36, the data received from the server 100 is analyzed to determine whether the data includes a BIP indicator. That is, it is determined whether a BIP indicator is present in the header or the first 16 rows of text in the message body of the subject email message. In this embodiment, the BIP indicator is located in the header, or on the first line of the email message. Because a BIP indicator is located in the first row of the message body, the facsimile machine 2 can easily determine whether attached data included in an email message is in BIP mode format or not without receiving and checking all the attached data. Also, the 16 rows of data received in S36 include information about whether the received email message is a divided part of the first ID number email message. Therefore, if the received email message is a divided part, the order of data from the divided first email message can be determined.

Once the procedures of S36 are completed, in S38, information on the type of email message and on whether the message divided into parts is added to the TOP LIST, as shown in FIG. 6B. The information about the type of email message indicates whether the received email message, the first email message in this embodiment, is a BIP type or an iFAX type. If the email message was divided before being transmitted, then information is provided that indicates the order of the received email message.

Once S38 is completed, it is determined in S40 whether or not all email messages have been analyzed. If not (S40:NO), then steps S34 to S40 are repeated to analyze the second and further email messages. Once all email messages have been analyzed (S40:YES), the program returns to the main routine 70a, and starts to perform the iFAX reception routine of S5.

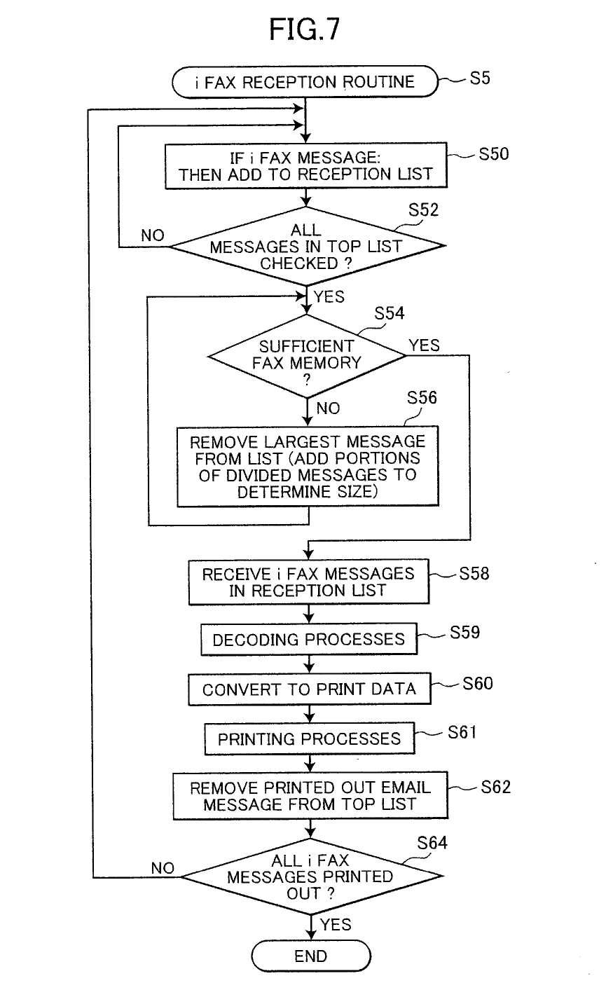

Once the list preparing routine of S3 is completed, the iFAX reception routine of FIG. 7 is executed. First, in S50, the facsimile machine 3 searches the TOP LIST in the order of the ID numbers. If the facsimile machine 2 finds any iFAX email messages, the facsimile machine 2 adds these email messages to a reception list. In S52, it is determined whether all IDs in the TOP LIST have been searched. The TOP LIST is searched in S50 until it is determined that all IDs have been searched (S52:YES).

Once all IDs in the TOP LIST are searched (S52:YES) then in S54, it is determined whether the sum of the size of all email messages in the reception list is greater than the capacity of the memory 74. In S54, if it is determined that the total size of all the email messages in the reception list is greater than the capacity of the memory 74 (S54:NO), then the program proceeds to S56, where the largest email message is removed from the reception list. All parts of a divided email message are added together to determine if the sum of all the divided email message is the largest email message. If the total of the divided parts is the largest email message, all parts of the divided message are removed from the reception list. The steps S54 to S56 are repeated until the sum of the size of all email messages in the reception list is less than the capacity of the memory 74.

Once it is determined that the sum of the size of the email messages is less than the capacity of the memory 74 (S54), then the program proceeds to S58, where the facsimile machine 2 receives the email messages remaining in the reception list from the server 100. Then in S59, the attached data attached to the received email messages is decoded according to MIME standards into TIFF-F image data. Then, in S60, the image data is converted into print data for printing. In S61, printing processes are performed based on the print data. That is, the steps S59 to S61 correspond to the first type of printing process. In S62, the email message printed out in S61 is removed from the TOP LIST. Then in S64, the TOP LIST is referred to determine whether any data for an iFAX message remains in the TOP LIST. If some iFAX email messages remain unprocessed (S64:NO), the steps S50 to S64 are repeated. Once all of iFAX email messages have been printed out (S64:YES), the iFAX reception routine of S5 is completed. The program then returns to the main routine.

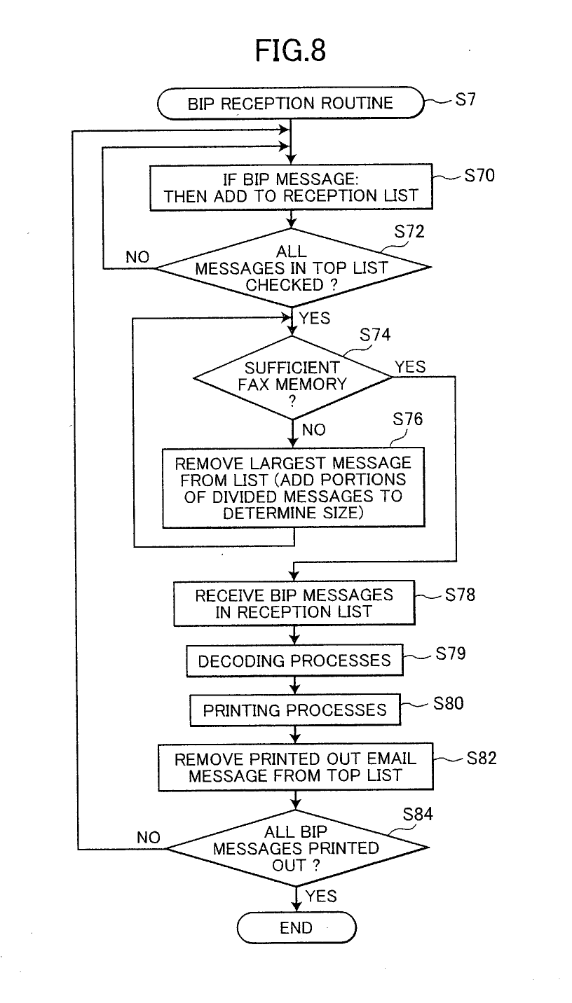

Once the iFAX reception routine of S5 is completed, then the BIP reception routine of S7 is performed in accordance with the flowchart of FIG. 8. First, in S70, the TOP LIST is searched in the order of the ID numbers. Each time a BIP email message is found, the email message is added to a reception list. Then, it is determined in S72 whether all IDs in the TOP LIST have been searched. The TOP LIST is searched in S70 until it is determined that all IDs have been searched (S72:YES).

Once all IDs in the TOP LIST are searched (S72:YES) then in S74, it is determined whether the sum of the size of all email messages in the reception list is greater than the capacity of the memory 74. If in S74, it is determined that the total size of all the email messages in the reception list is greater than the capacity of the memory 74 (S74:NO), then in S76, the largest email message is removed from the reception list. All portions of a divided email message are added together to determine if the sum of the size of the divided email message is the largest email message. If the total of the divided parts is the largest email message, then all parts of the divided message are removed from the reception list. The steps 74 to 76 are repeated until the sum of the size of all email messages in the reception list is less than the capacity of the memory 74.

Once it is determined that the capacity of the memory 74 is greater than the total size of the email message in the reception list (S74), then in S78, the facsimile machine 2 receives the email messages remaining in the reception list from the server 100. Then go to S79, where the data attached to the received email messages is decoded according to MIME standards into print data. Then in S80, printing is performed using the print data. That is, the steps of S79 to S80 correspond to the second type of printing process. In S82, the email message printed out in S80 is removed from the TOP LIST. Then in S84, the TOP LIST is referred to determine whether any data for a BIP message remains in the reception list. If not all BIP email messages have been processed (S84:NO), then the steps S70 to S84 are repeated. Once all BIP email messages have been printed out (S84:YES), then the BIP reception routine of S7 is completed, and the program returns to the main routine.

Next, advantages of the present invention will be described.

The type of the file attached to a received email message is distinguished in S36 of the list preparing routine of S3. Then, a printing process is selected depending on the type of the attached file; iFAX system or BIP system. The recorder 26 is controlled according to the selected printed process to form images based on the attached data onto recording sheets 24.

Accordingly, whether received email messages include attached data in BIP system or iFAX system, the type of the attached data is properly distinguished in S36. Printing processes are then performed in S61 or S80 in accordance with distinction results. Therefore, images based on the attached data can be formed on the recording sheets 24. For this reason, regardless of the type of attached file, both network print transmission and facsimile transmission over the Internet can be performed.

In the present invention, each email message may include an indicator in addition to the attached data. The indicator represents that the type of data before being encoded for the network facsimile transmission was print data. The presence or absence of the indicator is distinguished in S36, so that the type of the attached data is determined. In other words, the detection of the indicator clarifies the type of the attached data. Therefore, the type of the attached data can be easily distinguished without performing complicated processes such as analyzing all the contents of the attached data.

In the iFAX reception routine of S5, the TIFF-F image data must be converted into print data for printing. These data processes place a significant burden on the control portion 70. Therefore, when an iFAX email message is received and processed, the control portion 70 may be unable to perform other processes that require the scanner 22 and other components of the facsimile machine 2. On the other hand, during the BIP reception routine of S7, the attached data itself consists of print data, so that the conversion of image data to print data such as the iFAX reception routine of S5 is not necessary. Accordingly, the burden on the control portion 70 is not so great when the facsimile machine 2 receives BIP email messages. The scanner 22 of the facsimile machine 2 can be used even if BIP email messages are being received.

Generally, the user of the facsimile machine 2 will not be dissatisfied even if the user cannot to use the facsimile machine 2 immediately after starting receiving email messages. However, if the facsimile machine 2 is spending a lot of time for forming images based on an email message, the use may feel some dissatisfaction.

In this embodiment, the iFAX reception routine of S5 is performed before the BIP reception routine of S7. Therefore, a time period required from start of email message reception to the time when the scanner and other functions of the facsimile machine 2 are ready for usage is shortened, compared to the case in that the iFAX reception routine follows the BIP reception routine. Because the user will be able to use other functions of the facsimile machine 2 within a short time after email message reception starts, the user of the facsimile machine 2 will not feel any dissatisfaction due to the time period necessary for printing image data based on the network facsimile transmission.

When BIP email messages are received after iFAX email messages are received, the processing burden is reduced in a consecutive manner after iFAX processes are completed. However, when iFAX email messages are received after BIP email messages are received, the processing burden increases at the time when iFAX processes begin. As a result, the period of reduced processing burden is intermittent.

Because the facsimile machine 2 can also transmit and receive facsimile data over a telephone network, the user can select a method suitable for more beneficial transmission method.

For example, although the embodiment describes the facsimile machine 2 as being connected to the server 100 via a LAN, the facsimile machine 2 could be connected to the server 100 through a telephone network instead.

The description of the above embodiment explains the present invention as being applied to the facsimile machine 2. The present invention may be applied to any image forming apparatus that is capable of receiving email messages and also forming images based on data attached to the email messages. It should be noted that the image forming device may not have a scanner function or a copy function, for example.

The embodiment describes that iFAX system and BIP system are distinguished based on the header received form the server or the first 16 rows of text from the message body. However, other methods for distinguishing between iFAX format and BIP format can be used instead.

While the invention has been described in detail with reference to specific embodiments thereof, it would be apparent to those skilled in the art that various changes and modifications may be made therein without departing from the spirit of the invention, the scope of which is defined by the attached claims.

What is claimed is:

1. A printer comprising:
a receiving unit that receives, across an email transmission network, an email message attached with data;
an image forming unit that forms an image on a sheet; and
a control unit that controls the image forming unit to form on the sheet an image based on the data attached to the email message, the control unit including:
a determination unit that determines type of the attached data; and
a selection unit that selects a printing process in accordance with the type of the attached data as determined by the determination unit, the control unit controlling the image forming unit in accordance with the printing process selected by the selection unit.

2. A printer as claimed in claim 1, wherein the email transmission network is at least one of the Internet and a local area network.

3. A printer as claimed in claim 1, wherein the email message includes an indicator showing the type of the attached data, and the distinction unit distinguishes the type of the attached data using the indicator.

4. A printer as claimed in claim 1, wherein the control unit includes a transmission order selector that, before the receiving unit receives an email message, controls the receiving unit to receive, from a mail server connected to the email transmission network, email information about email messages to be received and, based on the email information, designates the order in which the receiving unit receives email messages.

5. A printer as claimed in claim 1, further comprising a facsimile reception unit that receives facsimile data across a telephone network, the control unit controlling the image forming unit to form on sheets images based on the facsimile data when the facsimile reception unit receives facsimile data.

6. A printer comprising:
a unit that accesses a mail server of an email transmission network to obtain information related to the email arrived at the server;
a unit that makes a list of the email based on the information;
a determination unit that determines type of data attached to the email on the list to classify the email into two groups of email according to determined type;
a receiving unit that receives one of the two groups of email from the mail server;
a selection unit that selects one of two different types of printing processes that corresponds to the received group of email;
an image forming unit that uses the selected printing process to form an image according to the data attached to the received email.

7. A printer as claimed as in claim 6, wherein the determination unit determines whether the type of data attached to the email is based on print data or image data, and wherein if the list includes the two groups of email, the receiving unit receives the group of email with attached data based on image data before the group of email with attached data based on print data.

8. A printer as claimed in claim 6, wherein the email transmission network is at least one of the Internet and a local area network.

9. A printer as claimed in claim 6, wherein the email includes an indicator showing the type of data attached to the email, and the determination unit determines the type of the attached data by using the indicator.

10. A printer comprising:
a receiving unit that receives email attached with data transmitted over a transmission network;
a decoding unit that decodes the data attached to the email;
a determination unit that determines whether the decoded data is image data or print data;
a conversion unit that converts the image data to the print data; and
an image forming unit that forms an image on a sheet according to the print data, wherein the conversion unit is activated only if the decoded data is image data.

11. A printer as claimed in claim 10, wherein the email transmission network is at least one of the Internet and a local area network.

12. A printer as claimed in claim 10, wherein the printer is connected to a server of the email transmission network, the printer further comprising:
a unit that obtains, from the server, information relating to email arrived at the server; and
a unit that makes a list of the email based on the information, wherein the receiving unit determines which email should be received referring to the list.
